(19) United States
(12) Patent Application Publication
(10) Pub. No.: US 2011/0172821 A1
(43) Pub. Date: Jul. 14, 2011

(54) AUTOMATED TIRE INFLATION SYSTEM

(76) Inventor: George Carter, Lucas, TX (US)

(21) Appl. No.: 12/685,434

(22) Filed: Jan. 11, 2010

(51) Int. Cl. G05B 15/00; B60S 5/04

(52) U.S. Cl. 700/259; 141/192; 141/1

(57) ABSTRACT

A system and method for automatically inflating tires mounted on a vehicle without requiring the occupants of the vehicle from leaving the interior of the vehicle. In one aspect, the present invention is directed to a system for automatically inflating a tire of a vehicle. The system determines a location of a valve stem of the tire and a robotic arm for inflating the tire. The robotic arm attaches to the located valve stem based on the determined valve stem location. The robotic arm supplies air to the tire from an air supply. The valve stem is located and the robotic arm attaches to the valve stem based on the determined valve stem location, inflates the tire and detaches from the tire upon determining that a predetermined tire air pressure is attained.

### BACKGROUND OF THE INVENTION

1. Field of the Invention

This invention relates to vehicular maintenance. Specifically, and not by way of limitation, the present invention relates to an automated tire inflation system and method.

2. Description of the Related Art

There are over 250 million vehicles on the United States roads today. These vehicles require periodic maintenance in order to keep the vehicles running efficiently and safely. One such maintenance item is the periodic inflation of air into the vehicle's tires. Due to normal tire leakage, on average, a vehicle's tires lose one to two pounds per square inch a month. Without proper inflation of a vehicle's tires, gas consumption increases dramatically. With the current oil crisis, it is imperative that each vehicle is efficiently operating to ensure that the vehicle operates at an optimum level without consuming more gas than is necessary. Additionally, from a safety standpoint, proper tire inflation is necessary for the vehicle's tires to grip the road properly and prevent inadvertent slipping on the road. In particular, the effectiveness of under-inflated tires on wet roads is even worse.

However, although most people are aware of the importance of proper inflation of tires, the National Highway traffic Safety Administration (NHTSA) estimates that 30 percent of vehicles on the road have one or more tires which are substantially underinflated. There are several reasons why the tires are under-inflated. First of all, although not difficult, inflation of tires is tedious and can be a dirty task for which many people do not wish to contend with. Additionally, most tire inflation stations are located outside and many people do not want to remain outside in hot or cold weather, even though it is only for a few minutes. Furthermore, full service gas stations are a rarity. With most people's busy schedules, most vehicle owners also do not remember to check the tire pressure for their vehicles. Additionally, although many people go to dedicated lube and oil stations to service the oil in the vehicle which usually entails checking the tire pressure, with new advanced oil, many vehicles are going a longer period of time between the servicing of oil. Furthermore, tire pressure monitors do not trigger an alert until a tire's pressure falls 25% below manufacturer's recommended tire pressure. With many people relying on these tire pressure monitors to alert them of underinflated tires, there is a further section of the driving population which do not drive with properly inflated tires.

Thus, it would be advantageous to have a system and method to automatically inflate the tires of a vehicle to a proper pressure which is convenient and does not result in the driver leaving the vehicle. It is an object of the present invention to provide such a system and method.

### SUMMARY OF THE INVENTION

The present invention provides a system and method for automatically inflating tires mounted to a vehicle without requiring the occupants of the vehicle from leaving the interior of the vehicle. In one aspect, the present invention is directed to a system for automatically inflating a tire of a vehicle. The system determines a location of a valve stem of the tire and a robotic arm for inflating the tire. The robotic arm attaches to the located valve stem based on the determined valve stem location. The robotic arm supplies air to the tire from an air supply. The valve stem is located and the robotic arm attaches to the valve stem based on the determined valve stem location, inflates the tire and detaches from the tire upon determining that a predetermined tire air pressure is attained.

In another aspect, the present invention is directed to a method of automatically inflating a tire mounted on a vehicle. The method begins by determining a location of a valve stem of the tire. A robotic arm attaches to the valve stem based on the determined valve stem location and supplies air to the tire. The robotic arm supplies air to a level sufficient to attain a predetermined tire air pressure and then detaches from the valve stem.

In still another aspect, the present invention is directed to an air station for automatically inflating a tire mounted on a vehicle. The air station includes an enclosure. The location of a valve stem of the tire is determined, the vehicle is immobilized when inflating the tire of the vehicle, and a robotic arm attaches to the located valve stem based on the determined valve stem location and supplies air to the tire from the air supply. Upon determining that a predetermined tire air pressure is attained, the robotic arm detaches from the valve stem.

### BRIEF DESCRIPTION OF THE DRAWINGS

FIG. 1 is a block diagram of an automated tire inflation system 10 in the preferred embodiment of the present invention;

FIG. 2 is a plan view of the automated tire inflation system 10 within the air station 12 in one embodiment of the present invention;

FIG. 3 is an end view of the extension 76 of a robotic arm depicted in FIG. 2; and

FIGS. 4A-4D is a flow chart illustrating the steps of automatically inflating tires mounted on a vehicle according to the teachings of the present invention.

### DESCRIPTION OF THE INVENTION

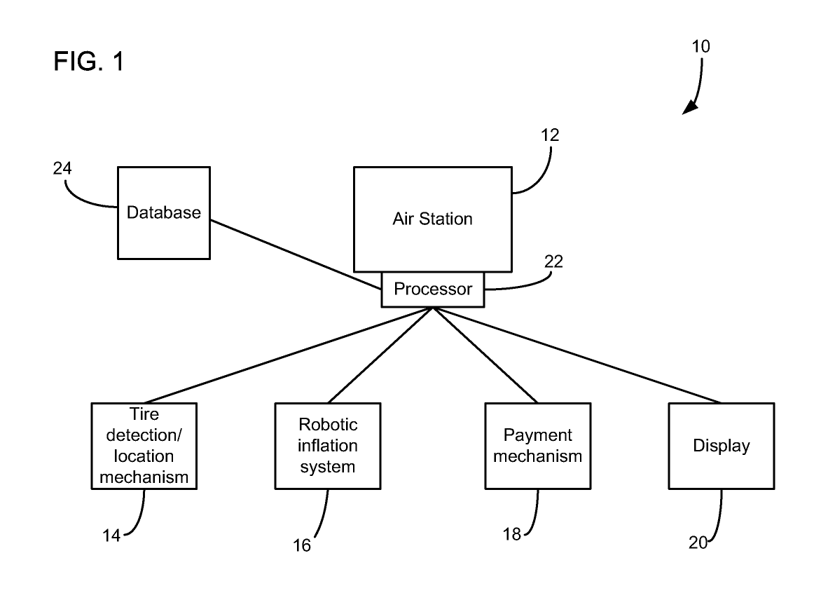

The present invention is an automated tire inflation system and method. FIG. 1 is a block diagram of an automated tire inflation system 10 in the preferred embodiment of the present invention. The automated tire inflation system includes an air station 12 having a tire detection/location mechanism 14, a robotic inflation system 16, an optional payment mechanism 18, an optional display 20, and a processor 22 for controlling the operation of the air station 12.

The air station may be an enclosed structure having a roof and walls housing the robotic inflation system, display 20 and the processor 22. The payment mechanism 18 may be located either inside the air station or located at an entry of the air station. Alternatively, or in conjunction with the payment mechanism 18, the system may store vehicle information obtained from a previous use of the air station by the vehicle in a central database 24. From this previous use of the air station by the vehicle, the air station may store information, such as desired tire pressure of the tires and an identifying indicia (e.g., license plate or identification card), in the central database. The central database may be available to other air stations to retrieve information when the vehicle utilizes the air station. Furthermore, the central database may store payment information, such as credit card information, which negates the necessity for a driver to utilize the payment mechanism 18. Additionally, a person may register a vehicle with relevant tire information and payment invention via the Internet, which may be conveyed to the central database. The system may recognize previous uses of the air station by the vehicle by recognizing the license plate number, a specific identification card or other identifying mechanism. In another embodiment, the air station may be an open-air facility.

The tire detection/location mechanism 14 provides a capability for detecting and locating the tires and valve stem, which is necessary for inflating the tires. In one embodiment, the present invention may utilize a structured light or laser system for scanning the tire to determine various types of information on the tire, such as the location of the valve stem, the tread depth of the tire, type of tire, etc. In another embodiment, the tire detection/location mechanism 14 may utilize an optical system (e.g., cameras) for recognizing and locating the valve stem.

The robotic inflation system 16 may be any device which automatically inflates the tire. In one embodiment, the robotic inflation system utilizes one or more robotic arms having the capability of optionally removing a valve stem cap, connecting the valve stem with an air compressor, monitoring the air pressure of the tire, inflating the tire with air to a proper pressure, and optionally positioning the valve stem cap back on the valve stem. The robotic arm may be articulated enabling the retraction and extension of the robotic arm as necessary. Furthermore, the robotic arm may move in one or more axis, preferably having a five-axis motion capability, to enable the robotic arm to connect to the valve stem. The robotic arm is coupled to an air source, such as an air compressor.

The automated tire inflation system 10 may include the payment mechanism 18 providing information on instructions for using the tire inflation system, enable the user to input specific information on the vehicle and its tires, and pay for use of the system. The payment mechanism may include a conventional credit card payment device and may also include the capability of receiving cash. As discussed above, in conjunction with the payment mechanism 18 or in place of the payment mechanism 18, the system may store vehicle information obtained from a previous use of the air station by the vehicle in the central database 24. The central database may store payment information, such as credit card information, which negates the necessity for a driver to utilize the payment mechanism 18.

The automated tire inflation may also include a display 20 providing information on the servicing of the tire pressure to the vehicle's tires. The display may provide information on the air added to each tire, the previous and present tire pressure, as well as tread depth and condition of each tire.

The processor 22 may be any computing device enabling control of the robotic inflation system tire detection/location mechanism, the payment mechanism and display. The processor may also include a memory for storing information on the vehicle and its tires, enabling the automated tire inflation system to automatically inflate the tires to the proper pressure. In addition, the central database 24 may store vehicle information for use by one or more air stations. The processor may communicate with the central database via a wirelessly or wired communications link.

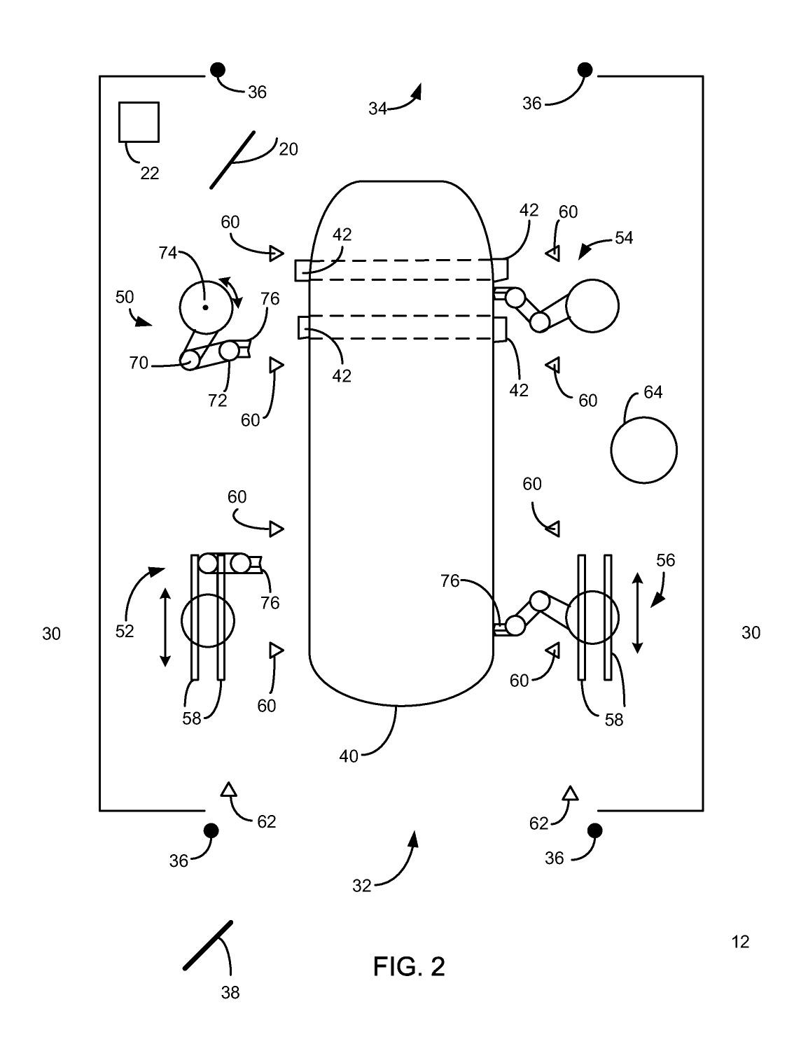

FIG. 2 is a plan view of the automated tire inflation system 10 within the air station 12 in one embodiment of the present invention. The air station includes an enclosure 30 for protecting the equipment of the automated tire inflation system 10 from inclement weather. The enclosure 30 may include an entrance 32 and an exit 34 protected by guard posts 36 to prevent damage by vehicles entering and exiting the enclosure 30. The payment mechanism 18 may be an entry terminal 38 located prior to the entrance of the enclosure or within the enclosure. The enclosure 30 is sized to accommodate a vehicle 40. The air station may include forward wheel blocks 42 to immobilize the vehicle during the operation of inflating the tires. The wheel blocks may extend upward from the ground to prevent movement of the vehicle. In an alternate embodiment of the present invention, the wheel blocks may be located to immobilize the rear wheels or all the wheels of the vehicle.

The air station 12 may utilize a plurality of robotic arms 50, 52, 54, and 56 in the robotic inflation system 16. The robotic arms may provide movement horizontally and vertically to position the robotic arms to align with the valve stem of a tire of the vehicle. As depicted in FIG. 2, the left robotic arms 50 and 52 are shown retracted and the right robotic arms 54 and 56 are shown extended toward the tires of the vehicle. The rear robotic arms 52 and 56 may be mounted on rails 58 to enable the rear robotic arms to be aligned adjacent the rear tires of the vehicle. Thus, the present invention may accommodate vehicles of various lengths.

The air station 12 may also utilize a plurality of wheel cameras 60 within the tire detection/location mechanism 14 to align the robotic arms with the tire valve stems through optically recognition and alignment techniques well known in assembly industries. The air station 12 may also include license plate cameras 62 to obtain information on the vehicle. The image of the license plate may be sent to the processor 22 for recognition of the characters on the license plate. The information on the license plate and associated tire pressure information may be stored in a memory of the processor. When the vehicle uses the system 10 again, the processor may recognize the license plate number, enabling the processor to determine the correct tire pressure from the previous use.

The air station may also house an air supply system 64 having an air compressor, pressure regulator, dryers, etc. which provides all the necessary equipment for supplying air to the tires of the vehicle. The display 20 may be located adjacent the driver's seat. The display may provide information on the vehicle, such as previous and current tire pressure, as well as provide an indication to the driver on when the vehicle is properly positioned in the air station 12. The processor may be located anywhere near the air station.

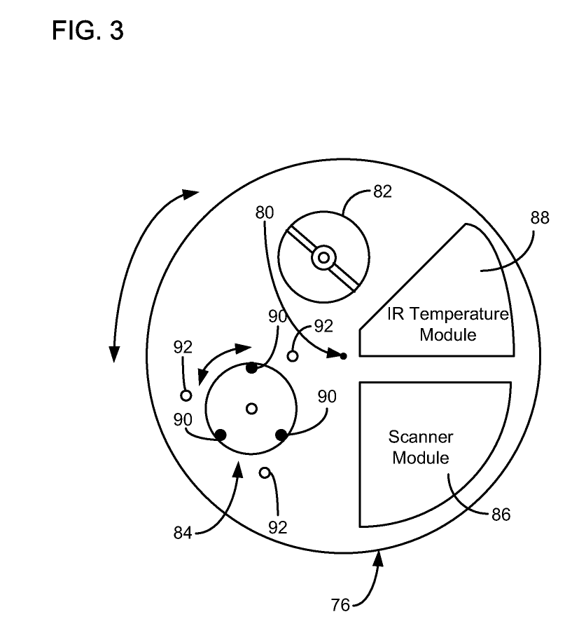

As depicted, the robotic arms each articulate at two points 70 and 72 to enable the robotic arm to extend and retract as necessary. The robotic arm may also rotate about a vertical axis about a point 74. Furthermore, the robotic arm may be able to vertically move up and down to accommodate the vertical position of the tire valve stem. As discussed above, the rear robotic arms may further move about the rails 58 to accommodate vehicles of various lengths. In the preferred embodiment of the present invention, the robotic arm has a five-axis motion capability. Each robotic arm may include an extension 76 which may include one or more cameras, a cap tool, an air chuck, an Infrared (IR) temperature sensor, and illumination devices for illuminating the tire. It should be understood that the robotic arms may be embodied in any fashion which enables the robotic arm to detect a valve stem and supply air to the tire and is not limited to the robotic arms depicted in FIGS. 2 and 3.

FIG. 3 is an end view of the extension 76 of a robotic arm depicted in FIG. 2. The extension provides an end portion of the robotic arm for engaging the valve stem of the vehicle's tire. Preferably, the extension 76 rotates about a point 80. The extension may include an air chuck 82, a cap tool 84, a scanner module 86, and an IR Temperature module 88. The air chuck 82 is sized and shaped to fit upon a standard tire valve stem. The system may include a tire air pressure sensing device to measure the pressure of the tire. The cap tool 84 may be used to remove a cap covering the tire valve stem. The cap tool may also include a plurality of telescopic fingers 90 for grasping the cap. The cap tool may also rotate in either direction to twist the cap off and place the cap on the valve stem after the tire has been filled with air. Additionally, the cap tool may include a plurality of cameras 92 with illumination devices for optically aligning the cap tool to the cap of the valve stem.

The scanner module 86 may be used either in place of or in conjunction with the wheel cameras 60 and 92 to align the cap tool and the air chuck on the tire stem. The scanner module may emit a structured light, such as a laser, upon the tire to detect the tire as well as the position and orientation of the valve stem. The structured light may reflect off the tire and be detected by the scanner module 86. Additionally, the extension 76 may also include the IR temperature module 88 for determining the temperature of the tire. It is well known that tire pressure is affected by temperature. Thus, to obtain an accurate and correct tire pressure, the IR temperature module may utilize an IR device to determine the temperature of the tire. This information may be sent back to the processor 22 for determination of the correct amount of air to inflate the tire.

With reference to FIGS. 1-3, the operation of the automated tire inflation system 10 will now be explained. The vehicle 40 may approach the air station 12. Prior to using the air station, information and payment is entered into the entry terminal 38. Preferably, the driver may provide payment using a credit card, a debit card or cash. Additionally, the user may provide some identification of the vehicle or owner of the vehicle, such as a card or other identifying information (e.g., telephone number, address, license plate number, etc.). This information may be used to determine the proper pressure of the tires. Alternately, the driver may provide the type and size of tire or vehicle make and model. In an alternative embodiment of the present invention, the license plate cameras 62 may capture an image of the vehicle 40 which is sent to the processor 22. The processor 22 may implement an image recognition program to determine the license plate number and check the license plate number with any stored license plate numbers (e.g., previous use of the system by the vehicle) stored in the database 24 to determine the proper tire pressure for the vehicle's tires. Furthermore, the central database may store payment information associated with the vehicle, thereby negating the necessity to provide payment information to the entry terminal. Upon payment and optional data entry, the driver enters the enclosure 30 through the entrance 32. The vehicle is then positioned by the driver in the enclosure 30. Indication or cues of the proper position of the vehicle may be obtained from the display 20. For example, a green light may be illuminated to indicate that the vehicle should move forward. A red light may indicate that the vehicle should stop. The front wheels may be positioned within a detent on the ground to indicate the proper position for the vehicle. Next, the vehicle position may be optionally secured. As depicted in FIG. 2, the front wheels are blocked by the wheel blocks 42 which extend upwardly to prevent movement of the vehicle. However, wheel blocks may be positioned upon any tires of the vehicle. The display 20 may provide an indication for the driver to shut the engine off. A microphone may be used to verify that the engine is shut down.

Next, the rear wheels are located. The system 10 utilizes the tire detection/location mechanism 14 to locate the position of the rear wheels. Alternately, the processor may determine the location of the rear wheels by accessing the processor memory which may store the location of the rear wheels by previous use of the system 10. The system may also use computer vision (CV) through the cameras 60 or through the scanner module 86 to determine the location of the rear wheels. Next, the rear robotic arms 52 and 56 are moved upon the rails 58 to align the robotic arms with the rear wheels of the vehicle in a similar fashion as a computer numerical controlled (CNC) device is moved to a proper position.

In one embodiment, the scanner module may be used to read the imprint of the tire size to determine or verify the correct pressure. Additionally, the scanner module may be used to determine the tread condition and provide an indication if tires need to be replaced. The tread condition may be determined by the robotic arm moving to a position adjacent the tire tread to view the tire tread.

Next, the tire valve stem is located by the CV of the tire detection/location mechanism 14 (e.g., the cameras and/or scanner module). Next, the robotic arm and extension 76 are aligned with the valve stem by extension of the robotic arm as well as repositioning of the vertical and horizontal position of the robotic arm. Next, the valve cap is detected and removed by the cap tool 84. In one embodiment, the telescopic fingers grasps, rotates and removes the cap from the valve stem. The fingers may include touch sensors to refine the position of the cap tool. Next, the extension 76 rotates to position the air chuck 82 adjacent the valve stem. The air chuck then extends to engage the valve stem. The system may then check the pressure of the tire. The temperature of the tire may then be determined by the IR temperature module 88. Information of the pressure and temperature of the tire is then sent to the processor 22. In one embodiment, the information is transmitted to the processor. The processor then determines the proper amount of air to supply the tire and commands the air chuck to supply the determined air to each tire. The pressure is then re-checked and air is then added or removed as necessary.

The extension 76 of the robotic arm is then rotated to position the cap tool 84 adjacent the valve stem. The cap is then positioned upon the valve stem by rotating the cap on the valve stem. The robotic arm is then retracted. Information on the amount of air added, previous tire pressure and current tire pressure may also be displayed on the display 20. Next, the wheel blocks are retracted. The display may provide a cue to the driver to start the engine and exit the enclosure through the exit 34. The processor may also generate a report which is optionally sent via email to the vehicle's owner's email address or printed out at the air station for dissemination to the driver of the vehicle. In addition, the processor may store vehicle information and/or payment information in the central database or processor memory.

The present invention may utilize one or more robotic arms to properly inflate the tires. In the preferred embodiment of the present invention, four robotic arms are used to accommodate all four wheels simultaneously. In additionally, currently there are caps which are double seal or fill through caps. Inflation of these tires may be accomplished without removing the caps. In such valve stems, the present invention may detect the presence of such valve stems and delete the process of removing a cap.

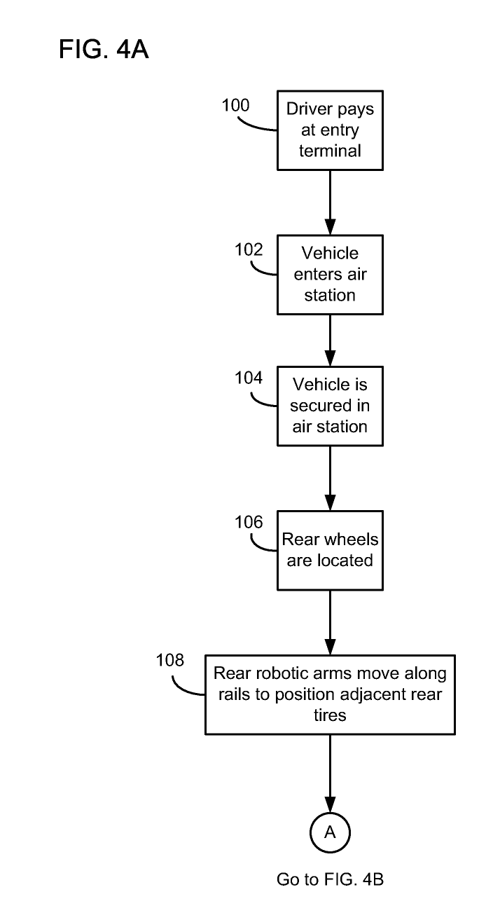

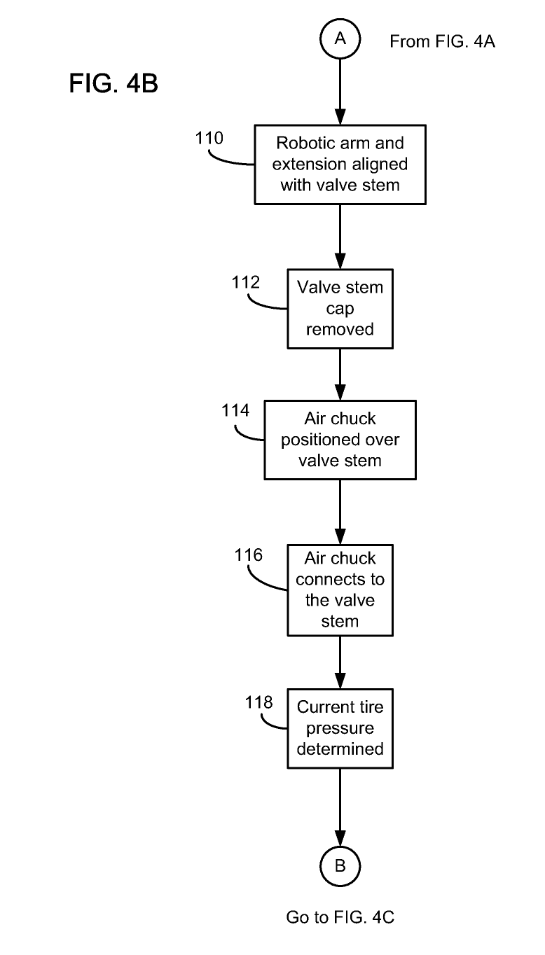

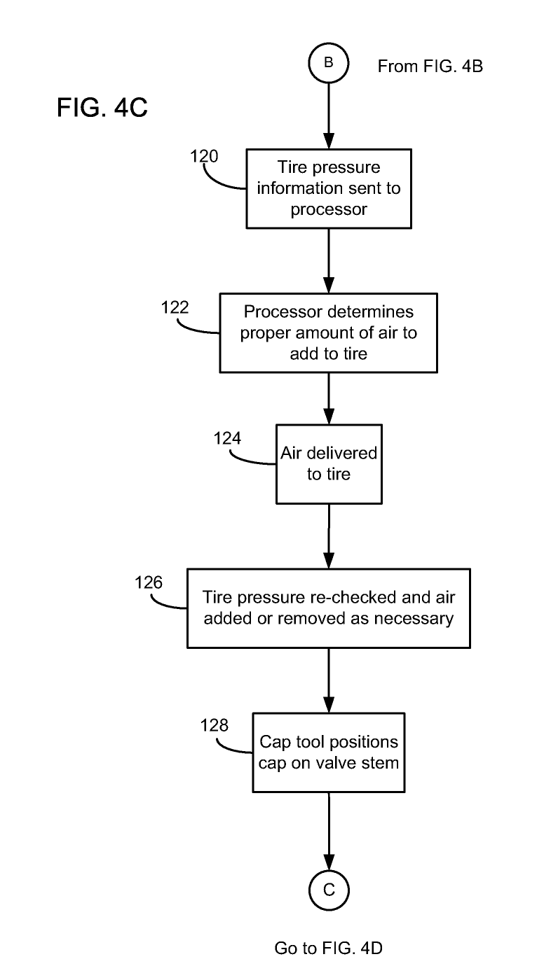

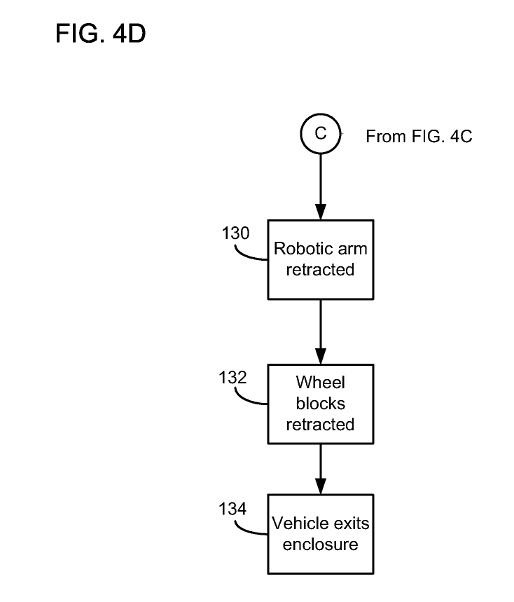

FIGS. 4A-4D is a flow chart illustrating the steps of automatically inflating tires mounted on a vehicle according to the teachings of the present invention. With reference to FIGS. 1-4, the method will now be explained. The method begins in step 100 where the driver provides payment and optionally provides relevant information to the entry terminal 38. Preferably, the driver may provide payment using a credit card, a debit card or cash. Additionally, the user may provide some identification of the vehicle or owner of the vehicle, such as a card or other identifying information (e.g., telephone number, address, license plate number, toll tag, etc.). This information may be used to determine the proper pressure of the tires. Alternately, the driver may provide the type and size of tire or vehicle make and model. In an alternative embodiment of the present invention, the license plate cameras 62 may capture an image of the vehicle 40 which is sent to the processor 22. The processor 22 may implement an image recognition program to determine the license plate number and check the license plate number with any stored numbers in the central database 24 to determine the proper tire pressure for the vehicle's tires derived from previous uses of the system 10. Additionally, the central database may store payment information associated with the vehicle, which may negate the necessity of the driver providing payment information to the entry terminal. Next, in step 102, the driver, upon providing payment and optional data entry to the entry terminal 38, the driver enters the enclosure 30 through the entrance 32. The vehicle is guided by the display into a proper position within the enclosure to allow inflation of the tires. Indication or cues of the proper position of the vehicle may be obtained from the display 20. For example, a green light may be illuminated to indicate that the vehicle should move forward. A red light may indicate that the vehicle should stop. The front wheels may be positioned within a detent on the ground to indicate the proper position for the vehicle to the driver. Next, in step 104, the vehicle position may be optionally secured. As depicted in FIG. 2, the front wheels are blocked by the wheel blocks 42 which extend upwardly to prevent movement of the vehicle. However, wheel blocks may be positioned upon any tire of the vehicle. The display 20 may provide an indication for the driver to shut the engine off. A microphone may be used to verify that the engine is shut down.

Next, in step 106, the rear wheels are located. The system 10 may utilize the tire detection/location mechanism 14 to locate the position of the rear wheels. Alternately, the process may determine the rear wheels' positions by accessing the processor's memory to determine where the rear wheels are located, which may have been determined by previous uses of the air station. The system may also use CV through the cameras 60 or through the scanner module 86 to determine the location of the rear wheels. Next, in step 108, the rear robotic arms 52 and 56 are moved along the rails 58 to align the robotic arms with the rear wheels of the vehicle.

In one embodiment, the scanner module may be used to read the imprint of the tire size to determine or verify the correct pressure. Additionally, the scanner module may be used to check the tread condition and provide an indication if tires need to be replaced. The tread condition may be determined by the robotic arm moving to a position adjacent the tire tread to view the tire tread. In an alternate embodiment of the present invention, the scanner module may be located separately from the robotic arm.

The method then proceeds to step 108 where the valve stem for each tire is located by the CV of the tire detection/location mechanism 14 (e.g., the cameras and/or scanner module). Next, in step 110, the robotic arm and extension 76 are aligned with the valve stem. In step 112, the valve cap is detected and removed by the cap tool 84. In one embodiment, the telescopic fingers grasps, rotates and removes the cap from the valve stem. The fingers may include touch sensors to refine the position of the cap tool. Next, in step 114, the extension 76 rotates to position the air chuck 82 adjacent the valve stem. As discussed above, currently there are caps which are double seal or fill through caps. Inflation of these tires may be accomplished without removing the caps. In such valve stems, the present invention may detect the presence of such valve stems and delete the process of removing and repositioning a cap on the valve stem. The air chuck then connects to the valve stem in step 116. In step 118, the system determines the current tire pressure and optionally determines the temperature of the tire by the IR temperature module 88. Next, in step 120, information of the pressure and temperature of the tire is then sent to the processor 22. In step 122, the processor then determines the proper amount of air to supply the tire and commands the air chuck to supply the determined air to each tire. In step 124, the air is delivered to the tire. In step 126, the pressure is then re-checked and air is then added or removed as necessary.

Next, in step 128, the extension 76 of the robotic arm is then rotated to position the cap tool 84 adjacent the valve stem and the cap tool positions the cap back on the valve stem. In step 130, the robotic arm is then retracted. Information on the amount of air added, previous tire pressure and current tire pressure may also be displayed on the display 20. Next, in step 132, the wheel blocks are retracted. In addition, the display may provide a cue to the driver to start the engine and exit the enclosure through the exit 34. The processor may then optionally generate a report which may be sent via email to the vehicle's owner's email address or printed at the air station for immediate delivery to the driver. Furthermore, the processor may store information on the vehicle and/or payment information in the central database 24 or the processor's memory. In step 134, the vehicle exits the enclosure.

Although robotic arms and their attached extensions are described, it should be understood that any mechanism which enables the automatic inflation of tires may be used and still remain in the scope of the present invention. Also, the present invention may use one or more robotic arms. The tire detection/location mechanism 14 may be an optical system, a scanner module or any other mechanism which can detect and provide information on positioning the robotic arms to inflate the tires.

The present invention provides many advantages over existing inflation methods and systems. The present invention provides a simple system and method for automatically inflating tires. The present invention does not require the driver to exit the vehicle. Furthermore, the present invention provides a capability of determining the correct pressure for the vehicle's tires.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A system for automatically inflating a tire mounted on a vehicle, the system comprising:
means for determining a location of a valve stem of the tire;
an air supply; and
a robotic arm for inflating the tire, the robotic arm attaching to the located valve stem based on the determined valve stem location and supplying air to the tire from the air supply;
whereby the valve stem is located and the robotic arm attaches to the valve stem based on the determined valve stem location, inflates the tire and detaches from the tire upon determining that a predetermined tire air pressure is attained.

2. The system according to claim 1 wherein the means for determining a location of a valve stem of the tire is an optical system for visually determining the location of the valve stem.

3. The system according to claim 2 wherein the optical system includes at least one camera for visually detecting the valve stem.

4. The system according to claim 1 wherein the means for determining a location of the valve stem of the tire is a scanner module for emitting a structured light for determining the location of the valve stem.

5. The system according to claim 1 further comprising means for monitoring air pressure of the tire.

6. The system according to claim 1 wherein the robotic arm includes an infrared temperature module for monitoring the temperature of the tire.

7. The system according to claim 1 wherein the robotic arm is mounted on a rail allowing horizontal movement of the robotic arm relative to the vehicle.

8. The system according to claim 1 wherein the robotic arm includes means for moving in a plurality of axis relative to the vehicle.

9. The system according to claim 1 wherein the robotic arm includes an extension having an air chuck for supplying air from the air supply to the tire and a cap tool for removing and attaching a valve stem cap to the valve stem.

10. The system according to claim 9 wherein the cap tool includes a plurality of telescopic fingers for grasping the cap.

11. The system according to claim 1 wherein the tire of the vehicle includes a fill through cap which enables inflation of the tire without removal of the cap.

12. The system according to claim 1 further comprising a payment mechanism enabling a driver of the vehicle to pay for using the system for automatically inflating a tire.

13. A method of automatically inflating a tire mounted on a vehicle, the method comprising the steps of:
determining a location of a valve stem of the tire;
attaching a robotic arm to the valve stem based on the determined valve stem location;
supplying air to the tire by the robotic arm from an air supply, the robotic arm supplying air to a level sufficient to attain a predetermined tire air pressure; and
detaching the robotic arm from the valve stem.

14. The method according to claim 13 wherein the step of determining a location of a valve stem of the tire includes using an optical system for visually determining the location of the valve stem.

15. The method according to claim 14 wherein the optical system includes at least one camera for visually detecting the valve stem.

16. The method according to claim 13 wherein the step of determining a location of the valve stem of the tire includes using a scanner module for emitting a structured light for determining the location of the valve stem.

17. The method according to claim 13 wherein the step of supplying air to the tire including determining a current air pressure of the tire to determining when the predetermined air pressure is attained.

18. An air station for automatically inflating a tire mounted on a vehicle, the air station comprising:
an enclosure housing:
means for determining a location of a valve stem of the tire;
an air supply;
means for immobilizing the vehicle when inflating the tire of the vehicle; and
a robotic arm for inflating the tire, the robotic arm attaching to the located valve stem based on the determined valve stem location and supplying air to the tire from the air supply;
whereby the vehicle is positioned in the enclosure, the valve stem is located and the robotic arm attaches to the valve stem based on the determined valve stem location, inflates the tire and detaches from the tire upon determining that a predetermined tire air pressure is attained.

19. The air station according to claim 18 wherein the means for determining a location of a valve stem of the tire is an optical system for visually determining the location of the valve stem.

20. The air station according to claim 19 wherein the optical system includes at least one camera for visually detecting the valve stem.

21. The air station according to claim 18 wherein the means for determining a location of the valve stem of the tire is a scanner module for emitting a structured light for determining the location of the valve stem.

22. The air station according to claim 18 wherein the robotic arm includes means for monitoring air pressure of the tire.

23. The air station according to claim 18 wherein the robotic arm is mounted on a rail allowing horizontal movement of the robotic arm relative to the vehicle.

24. The air station according to claim 18 wherein the robotic arm includes means for moving in a plurality of axis relative to the vehicle.

25. The air station according to claim 18 wherein the robotic arm includes an extension having an air chuck for supplying air from the air supply to the tire and a cap tool for removing and attaching a valve stem cap to the valve stem.

26. The air station according to claim 18 wherein the robotic arm includes means for extending and retracting the robotic arm relative to the vehicle.

27. The air station according to claim 18 further comprising a payment mechanism enabling a driver of the vehicle to pay for using the system for automatically inflating a tire.
